(19) United States
(12) Patent Application Publication
(10) Pub. No.: US 2004/0106382 A1
(43) Pub. Date: Jun. 3, 2004

(54) Repeater calibration system

(75) Inventors: Barry Mark Fisher, Dallas, TX (US); Jeramy Scott Leonard, Sachse, TX (US); James Lyn Alford, Garland, TX (US); Donald G. Jackson, Garland, TX (US)

Correspondence Address: WOOD, HERRON & EVANS, LLP, 2700 CAREW TOWER, 441 VINE STREET, CINCINNATI, OH, 45202, US

(73) Assignee: Andrew Corporation, Orland Park, IL

(21) Appl. No.: 10/308,546

(22) Filed: Dec. 3, 2002

(51) Int. Cl. H04B 1/38; H04B 1/40

(52) U.S. Cl. 455/87; 455/73

(57) ABSTRACT

A system calibrates the gain of a repeater by determining a value based on the difference between respective amplitude measurements made while the repeater is transmitting and while it is not. The value is compared to threshold data in order to determine whether repeater attenuation should be incrementally adjusted.

### FIELD OF THE INVENTION

The present invention relates to radio communication systems that utilize repeaters to improve signal coverage, and more particularly, to the management of interference in a repeater arising from feedback.

### BACKGROUND OF THE INVENTION

Numerous wireless communication applications, such as cellular and personal communication services (PCS), as well as multi-channel multi-point distribution systems (MMDS) and local multi-point distribution systems (LMDS), conventionally received and retransmit signals from subscribers utilizing transmissions to and from a base station. In some subscriber locations within the base station's coverage area (also known as a cell) natural or manmade obstructions may severely attenuate the radio signals. Thus, the transmissions may become too weak or undesirable for communication purposes. For example, a ravine, hill, building or walls in a building in the path of a transmission may result in unacceptable coverage between cells.

Repeaters are conventionally employed to extend and improve signal coverage within problematic coverage areas. That is, repeaters are positioned to retransmit and bolster the signals from a nearby cell into a low coverage area. The retransmitted signals may then be received by appropriate mobile units in the area. Likewise, transmissions from mobile units within the problem area can be retransmitted by the repeater such that they can be heard by the signal receivers at the base station site.

A conventional configuration for a repeater system 10 is shown in FIG. 1. In principle, a downlink signal from the base station 11 to a subscriber unit 16 is received by a repeater antenna 12. The signals are amplified by the repeater 13, then retransmitted by a second repeater antenna 14 to the subscriber unit 16. The repeater thus overcomes blockage 17 caused by terrain 15. Similarly, uplinks from the subscriber unit 16 to the base station 11 are received and retransmitted by the antennas 12 and 14 of the repeater such that the amplified, uplink signal arrives at the base station 11. For illustration, the repeater 13 is shown on a tower, but may also be placed on or in buildings or other appropriate support structures.

In practice, there is a finite amount of transmitted energy that is fed back to the respective receiving antennas in both the uplink and the downlink. The feedback may be attributable to imperfections in the antenna radiation patterns, for instance, and may produce interference and oscillation at the antennas. As implied above, the severity of the feedback may depend on an antennas' relative position and orientations, as well as the general propagation environment near the repeater.

To avoid oscillation and other detrimental effects of feedback, the amount of repeater gain must generally be no greater than the isolation between the antennas. Isolation between repeater antennas can be defined as the frequency-dependent power ratio of radiating signals received by one antenna and transmitted by another antenna, usually expressed in decibel (dB) units.

When accounting for isolation, network engineers typically estimate an appropriate setting for system signal attenuation so as to avoid the undesired condition of the repeater gain exceeding the isolation. By maintaining isolation at a much greater level than repeater gain, the likelihood of oscillation is diminished. However, while estimations are used, they present undesirable drawbacks.

For example, estimation remains largely dependent on trial and error which is time consuming and not always effective. Occurrences of oscillation still persist with such trial and error methodology. Additionally, there is little assurance that the optimal settings for the repeater have been achieved. More specifically, the gain of the repeater is often kept at an unnecessarily low level in an effort to overcompensate and avoid oscillation. This leads to inefficient performance of the repeater. Still further, conditions around the repeater may change over time, which changes the operating parameters. In such a case, the repeater will have to be reconfigured, which is time-consuming and expensive.

Thus, there exist a need for a more efficient and effective mechanism for addressing feedback in a repeater system. There is further a need to ensure optimal and efficient performance of a repeater while reducing the likelihood of oscillation. It is further desirable to have a repeater which is readily and easily adapted to different environments.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the present invention.

FIG. 1 shows a communications network;

FIG. 2 is a block diagram of a repeater system assembly having application within the communications network of FIG. 1;

FIG. 3 is a database schematic having application within the repeater system of FIG. 2; and

FIG. 4 is a flowchart having sequenced steps that are suited for execution within the repeater system of FIG. 2.

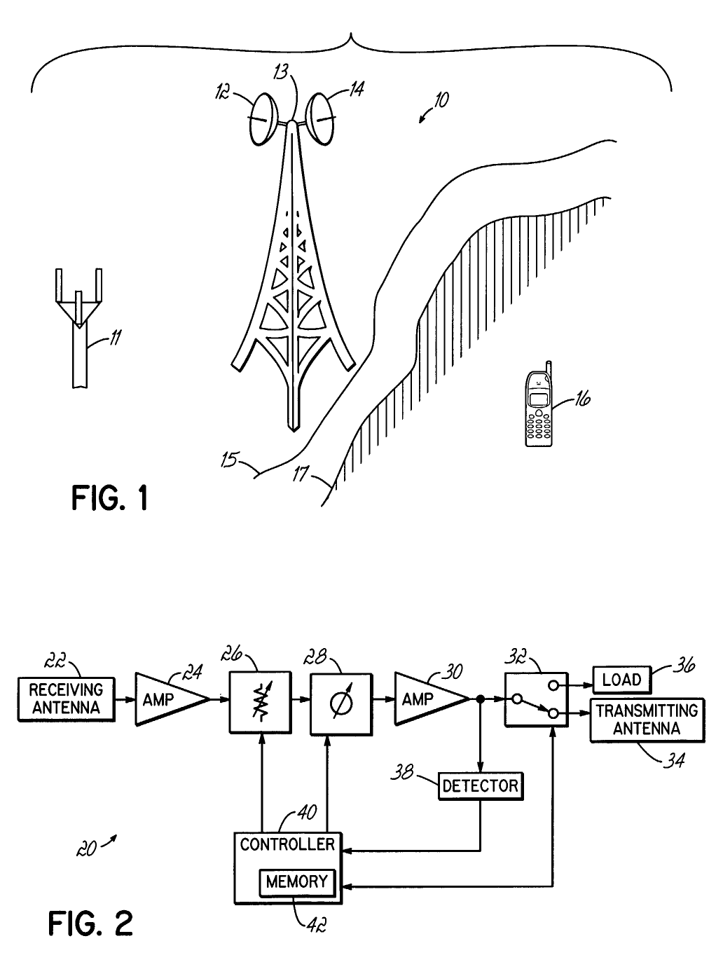

### DETAILED DESCRIPTION OF THE DRAWINGS

The invention addresses the above-discussed problems and issues associated with the prior art by providing a repeater system 20 configured to improve repeater system performance by, in one respect, managing feedback within repeater systems. The invention further provides for improved efficiency in the repeater and for improved adaptability to new or changing environments. The gain of the repeater is dynamically maximized while maintaining sufficient levels of feedback to prevent isolation. The gain is automatically adjusted in the invention so the repeater may readily and dynamically adjust to new or changing environments.

FIG. 2. shows an embodiment of one such repeater system 20 in accordance with the principles of the present invention. In the illustrated embodiment, the system 20 calibrates the gain of the repeater 20 by determining a mathematical value based on the difference between respective amplitude measurements. One amplitude measurement is typically conducted while the repeater 20 is transmitting, the other, while the repeater is not. The value is subsequently compared to stored threshold data in order to determine whether repeater attenuation should be incrementally adjusted.

Turning more particularly to the repeater system 20 shown in FIG. 2, an incoming RF signal arrives at a receiving antenna 22 of the repeater 20. The incoming signal may arrive from a base station or another repeater. For purposes of this specification, a suitable receiving antenna may include one or more elements configured to receive electromagnetic radiation, to include multiple, conventional antennas and antenna elements, where desired. The incoming signal may comprise any electromagnetic radiation, to include multiple signals received at multiple frequencies and having a plurality of modulation and transmission characteristics.

In the course of normal operations, the repeater 20 will accept incoming signals at the receiving antenna 22 as it simultaneously transmits processed signals from a transmitting antenna 34. As discussed herein, a portion of the outgoing signal transmitted from the transmitting antenna 34 is recognized or received as feedback at the input to the receiving antenna 22. The feedback may be attributable to system 10 design, positioning, spacing, terrain and power levels, among other considerations. For example, a combination of such factors can cause part of the transmitted signal to be reflected back to the receiving antenna 22. Thus, the incoming signal additionally includes some measure of feedback while the repeater 20 transmits. As discussed below in detail, embodiments of the present invention determine the level of feedback present in the incoming signal in order to set repeater gain to an appropriate level.

The incoming signal may be filtered and amplified subsequent to reception by the antenna 22, as is known in the art. For instance, the incoming signal is bolstered by a first amplifier 24. For purposes of this specification, a suitable amplifier 24 comprises multiple amplifiers and/or filter devices or stages.

The amplified signal is then passed through an attenuator 26. An attenuator 26 that is consistent with the principles o the present invention is configured to increase and/or decrease the gain of the repeater system. Increasing the setting of the attenuator 26, or the attenuation level, decreases the gain of the repeater system. In one embodiment, the attenuation level may be preset to a relatively high level. As will become clearer in the paragraphs that follow, the high attenuator setting serves to confine the initial gain of the repeater. Such a precaution may avoid incidence of oscillation at the onset of a calibration process. However, any initial attenuator setting can be used in accordance with the principles of the present invention, to include one used during a prior calibration process. The attenuator 26 receives such a setting from a controller 40 in communication with the repeater 20. The controller 40 thereafter dynamically instructs and sets the attenuator 26 per system requirements and protocol per the invention.

The attenuated signal arrives at the input of a variable voltage phase shifter 28. The phase shifter 28 sweeps through the entire 360 degree cycle of the sinusoidal, incoming RF signal to determine one or more peaks of the cycle. Controller 40 controls the phase shifter to achieve the sweep. The peak(s) typically coincide with the point(s) along the cycle where the amplitude of the incoming signal from the base station is at its highest mark. The amplitude at the peak additionally reflects the effects of feedback attributable to the outgoing signal from the transmitting antenna 34. In the closed loop condition, the RF delay between the TX antenna 34 and RX antenna 22 determines the frequency domain spacing of feedback ripples in the pass band. As noted, the phase shifter shifts the feedback ripple through its entire 360° sinusoidal cycle at any frequency. As is known in the art, the peak measurement further includes a more nominal noise floor. The noise floor may be attributable to the noise figure of a base station, the repeater, a cell phone, etc. As is known in the art, this noise remains proportionally small when compared to the combined amplitude attributable to the feedback and base station signal. Moreover and as described below, such noise is largely cancelled out in the processes used to calibrate the repeater system 10.

A suitable phase shifter 28 for purposes of this specification may comprise a device configured to align, present, or scan a signal in time as necessary to determine the location of a desired signal characteristic along the cycle of the signal. While a typical characteristic may include a registerable peak of the cycle, another phase shifter or combination of phase shifters according with the principles of the present invention may be used to determine another point along the cycle, to include a valley.

A power detector 38 samples the signal peaks as scanned and aligned by the phase shifter 28. The power detector 38 may be configured to sample the signal continuously or at preset intervals synchronized with the output from the phase shifter 28. Where desired, the power detector 38 may be hardwired into the output of an amplifier 30 (or succession of amplifiers) that receives and bolsters the signal from the phase shifter 28. The amplifier 30 boosts the amplitude of the signal to a level required for transmission to a subscriber unit or another repeater, for example.

One of skill in the art will appreciate that the positioning of the power detector 38 is not critical to the functionality of the present invention, and that one or more power detectors may be placed at different points along the transmission path of the repeater 20 per system specifications in accordance with the principles of the present invention. For instance, a power detector 38 of another embodiment may measure the signal peaks from a location remote from the amplifier 30 and/or repeater.

In any case, the power detected by the detector 38 while the repeater transmits is communicated to the controller 40. While a suitable controller may comprise a microchip, a controller 40 of another embodiment may include multiple processors and operating systems, as well as other computer technologies, to include networking capability to additional controllers. The controller 40 additionally has access to a memory 42, such as digital storage resident on a microchip. While shown as integral with the controller 40 in FIG. 2, it should be understood that suitable memory 42 may alternatively or additionally be physically located throughout a communication system, to include a database of a base station computer network.

The controller 40 stores the data measured and reported from the power detector 38 within memory 42 for further use. For instance, the controller 40 caches the peak measurements in such a manner as they may be readily recalled and compared against subsequent measurements received by the controller 40. The controller 40 may further process and otherwise format the measurements for subsequent processing. For instance, the controller 40 may average multiple peak measurements to determine a single, median measurement. Where desired, such averaging may serve to mitigate the occurrence of statistical anomalies that may be introduced in the course of a calibration process.

The stored measurement is typically recorded electronically in association with the transmitting status of the repeater 20. For example, a database field containing the stored measurement may link to another field indicating that the measurement was taken while feedback from the transmitting antenna 34 was present in the signal. In another embodiment, measurements taken from earlier applications or input from a technician are stored within memory 42 and maintained as a transmitting measurement in lieu of no new measurements. Thus, it may be possible to calibrate a repeater system in accordance with the present invention without first capturing the transmitting signal. Rather, a stored value may be recalled and used in place of the transmitting measurement. As discussed below in greater detail, another embodiment may obviate a non-transmitting measurement by measuring the valleys of the sinusoidal signal.

The controller 40 may further operate a switch 32 that functions to direct the signal from the amplifier 30 to the transmitting antenna 34 of the repeater 20. For purposes of this specification, a suitable transmitting antenna 34, like the receiving antenna 22, may comprise any device configured to receive and/or transmit electromagnetic energy. The transmitting antenna 34 sends the amplified signal(s) to subscriber units and/or another repeater as is conventionally accomplished. Thus, one of skill in the art will appreciate that calibration processes of an embodiment of the present invention is compatible with the operation of known systems.

The controller 40 may send a subsequent signal to the switch 32 to reroute the signal path away from the transmitting antenna 34. As shown in FIG. 2, the switch 32 diverts power from the amplifier 30 to a load 36, such as a 50 Ohm load, from which no signal is emitted. Thus, a suitable switch 32 may comprise any device configured to direct power toward (closed loop) and away from the transmitting antenna 34 to load 36 (open loop). As such, the switch 32 may be positioned at multiple points along the repeater 20 in accordance with the underlying principles of the present invention.

While the signal from the transmitting signal remains interrupted, no feedback from the signal is reflected back to the receiving antenna 22. Thus, the incoming signal at the receiving antenna 22 consists only of the signal from the base station and the noise floor (i.e., open loop). An embodiment of the present invention capitalizes on the absence of the feedback to determine its affect on the performance of the repeater system 20. As the signal from the base station remains relatively constant, and as the noise floor is similarly constant and at least proportionally small as compared to the magnitude of the base signal (and feedback, when present), the open loop signal generally without feedback provides a reliable basis for comparison against the previously recorded closed loop signal that includes feedback.

As such, the detected signal may be processed by the amplifier 24 and attenuator 26 as before. Additionally, the phase shifter 28 sweeps the entire 360 degree cycle of the amplified and attenuated signal to present peak amplitudes to the power detector 38. The “open loop” status of the switch means that the repeater 20 does not transmit as the measurements are accomplished by the power detector 38. Without the feedback formerly present in the incoming signal, the measured peaks will be smaller than those detected in similar fashion while the repeater 20 was transmitting.

The power detector 38 communicates the measured peaks of the incoming signal to the controller 40 for analysis. As before, the controller 40 may process the values measured from the incoming signal to arrive at an average signal level. Thus, the controller 40 ultimately has access to the peak and/or averaged measurements taken both when the repeater 20 was transmitting and when it was not. Information gleaned from both signal measurements correlates to signals with and substantially without feedback, respectively.

In one embodiment, the controller 40 manipulates the stored measurements to arrive at a mathematical value. The value may thus be representative of some ratio, product or difference of the various measurements which have been made. For instance when a highly selective, narrow-bank filter is placed before the power detector 38, the controller 40 may determine the value using the equation for loop gain of: A₍ₗₒₒₚ₎=(Aₘₐₓ−Aₘᵢₙ)/(Aₘₐₓ+Aₘᵢₙ), where Aₘₐₓ and Aₘᵢₙ are the maximum and minimum measurements, respectively for the measurements taken as noted above in the closed loop condition. One of skill in the art should appreciate that there are any number of processing variations and functions that may be employed as an alternative or addition to the above equation. For example, the controller 40 of another embodiment may simply subtract the measurement not having feedback (open loop) from the measurement with feedback (closed loop), e.g., −25 dBm open loop (non-transmitting) measurement may be subtracted from a −20 dBm closed loop measurement. The difference between the two measurements may be indicative of the feedback present in the repeater 20.

This measured difference value may be stored as a value that is ultimately compared against threshold values. The comparison of such values results in instructions from the controller 40 to the attenuator 26 affecting the adjustment of system 20 gain in accordance with one aspect of the present invention. For instance, the controller 40 of one embodiment decrements the level of attenuation by 1 dB in response to the difference value [difference between the detected transmitting (closed loop) and non-transmitting (open loop) amplitudes] being smaller in magnitude than the threshold value recalled from memory 42.

Generally, the threshold value may comprise a number or registerable condition stored within memory 42 and correlated, such as in a look up table, to repeater isolation characteristics as they relate to various different measured values. Thus, the difference values determined by the controller 40 may readily be associated with applicable threshold values. The threshold value may be indicative of operating conditions of the amplifier. As such, the threshold value, and more particularly, a comparison between the threshold value and the measured value, may indicate how much loop gain a system can absorb while still operating in such a manner as to avoid the probability of oscillation or other undesirable performance. At the same time, the invention assures that the system operates at an efficient level. In this manner, results of a comparison between the measured values and the recalled/calculated threshold values may address to the isolation of the repeater system 20 under current conditions. The threshold value is thus used as a comparison point, or watermark, with which the controller 40 gauges and determines the operating status of the repeater system 20 in terms of the appropriateness of the attenuator setting and its overall gain.

As an example, a −20 dBm measurement may be made based on levels detected by the power detector 38 while the repeater 20 was actively transmitting. As discussed herein, this transmitting, or closed loop, measurement includes feedback that is present in the detected signal. A subsequent (or previous, where desired) measurement of −25 dBm made by the power detector 38 while the transmitting antenna 34 of the repeater 20 was inactive (open loop) may be subtracted from the closed loop measurement. Thus, the resultant difference value of 5 dB is indicative of the closed loop feedback and the resulting feedback loop gain present in the repeater system 20 under current operating conditions.

The controller 40 retrieves threshold data for comparison against the measured value. As discussed in greater detail below, the tabled threshold values may be selected in view of the particular operating conditions and hardware parameters of the repeater system 20. The magnitude of the threshold values may be preset as a ceiling tolerance of the repeater system 20. That is, a measured value that exceeds or approaches the threshold value in magnitude may statistically give rise to the probability of oscillation or some other effect that is detrimental to the operation of the repeater system 20.

In accordance with aspects of one embodiment of the present invention, the threshold value table may be populated according to known isolation and system tolerances. Such tolerances may be discovered through field experimentation and calculation, among other sources. The threshold values may be calculated and further organized within the memory 42 according to predetermined repeater conditions. For instance, the threshold values stored within memory 42 may vary according to the power level of the incoming signal, the attenuator setting and the actual system gain, among other considerations. Such operating conditions can affect repeater performance as they relate to feedback. Thus, the singular or cumulative impact of these factors on a system can skew the relationship between feedback and operating tolerance/isolation.

Consequently, different tables and/or algorithms may be employed to vary the threshold values appropriately in order to accommodate the different operating conditions. As such, while a given mathematical value may correlate to threshold values under certain operating conditions might be used in one instance or environment, the measured values may be compared to different threshold values under other conditions, such as where the power of the signal from the base station is discrepant.

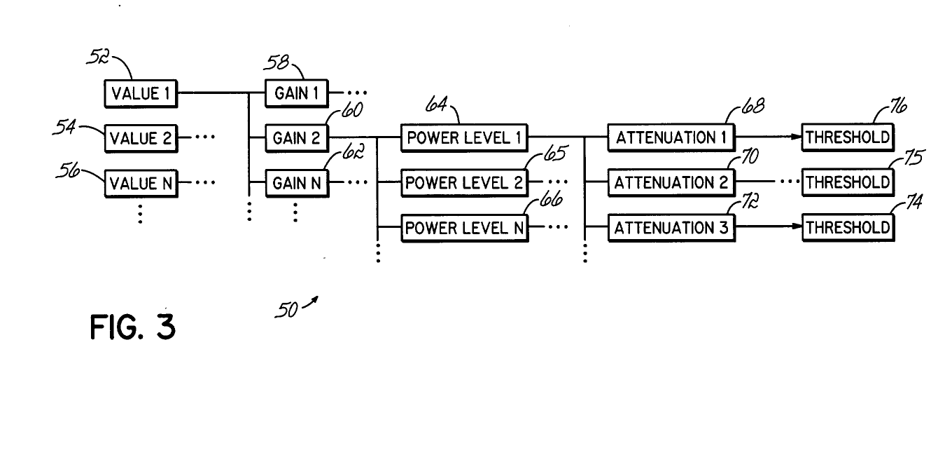

One of skill in the art will recognize that there are many number of different ways to store threshold data in accordance with the present invention. Nonetheless, the database schematic 50 of FIG. 3 shows an exemplary logical structure suited to store and recall threshold values for an embodiment of the present invention. As discussed herein, such threshold values may be stored in physical memory located throughout the system 10, local and remote to the controller 40.

The database schematic 50 of FIG. 3, in one respect, logically links a measured value 52 to appropriate threshold values 74. The logical connectivity within the exemplary schematic 50 accounts for different repeater system operating conditions, such as attenuator settings 68-72, power levels 64-66 of the incoming signals, and respective system gains 58-62. While these factors do affect the isolation of a repeater 20 under certain conditions, their inclusion within FIG. 3 is merely exemplary, and additional or alternative factors could be included as desired to affect the threshold values used in accordance with the invention.

In any case, the controller 40 may determine where to retrieve the threshold value 74 after first locating a database field 60 matching the requisite gain of the system. This gain may be preprogrammed into the controller 40, or accessed by the controller 40 from a local or remote location per operating protocol. The first database field 60 may link to a second field 64 associated with the current power level of the incoming signal. This second field 64, in turn, may link to a third field 72 that corresponds to the current setting of the attenuator 26. In this manner, the threshold value 74 ultimately retrieved from the database 50 is reflective of gain, power and attenuation factors. Such correlation may serve to more accurately reflect actual isolation within the repeater system 20.

While such factors 58-72 may particularly affect selection of the threshold value in some instances, It should be appreciated that numerous other considerations contributing to the determination of stored threshold value may be additionally or alternatively linked within the exemplary structure 50 of FIG. 3. Moreover, while storing threshold data within memory 42 presents particular advantages within certain applications of the present invention, one of skill will further appreciate that other techniques, to include calculations/algorithms, may alternatively be used to arrive at the same or substantially similar threshold values in accordance with the underlying principles of the present invention.

In accordance with another aspect of the invention, the retrieved threshold value is compared against the measured value determined from the sampled signals. Using such comparison, the present invention adjusts the gain of the repeater system to a level that will prevent oscillation while still providing optimal efficiency in the repeater. Such adjustment may be configured to operate automatically such that the repeater system is dynamically adjustable to adjust to changing parameters in its use. In operation, if the measured value is below the retrieved threshold value in one embodiment, it is indicative that the gain of the repeater system may be increased. The controller 40 operates the attenuator 26 to decrease the level of attenuation by 1 dB, or some other preset decrement, for example. As such, gain in the system 20 increases, and such gain is reflected as the measurement/calibration processes are repeated. One of skill in the art should further appreciate that the attenuation level of another embodiment that is consistent with the principles of the present invention may alternatively be incremented where necessary if the measured value exceeds the threshold.

The measurements, value/data comparisons and gain adjustment repeats until the magnitude of the measured value exceeds that of the threshold data, at which time the gain of the repeater 20 is not to be further increased. In one embodiment, normal operation of the repeater system 20 may resume at the current gain. Alternatively, as a precautionary measure, the controller 40 may additionally increase the attenuation slightly, e.g. by 5 dB, to provide a final measure of security against oscillation. That is, the system gain may be adjusted to its highest gain where it just exceeds or is equal to the threshold value, then it might be left at that gain or backed slightly down for the prevention of oscillation. Where desired, the threshold value and/or attenuator setting may be stored within memory 42 for further evaluation.

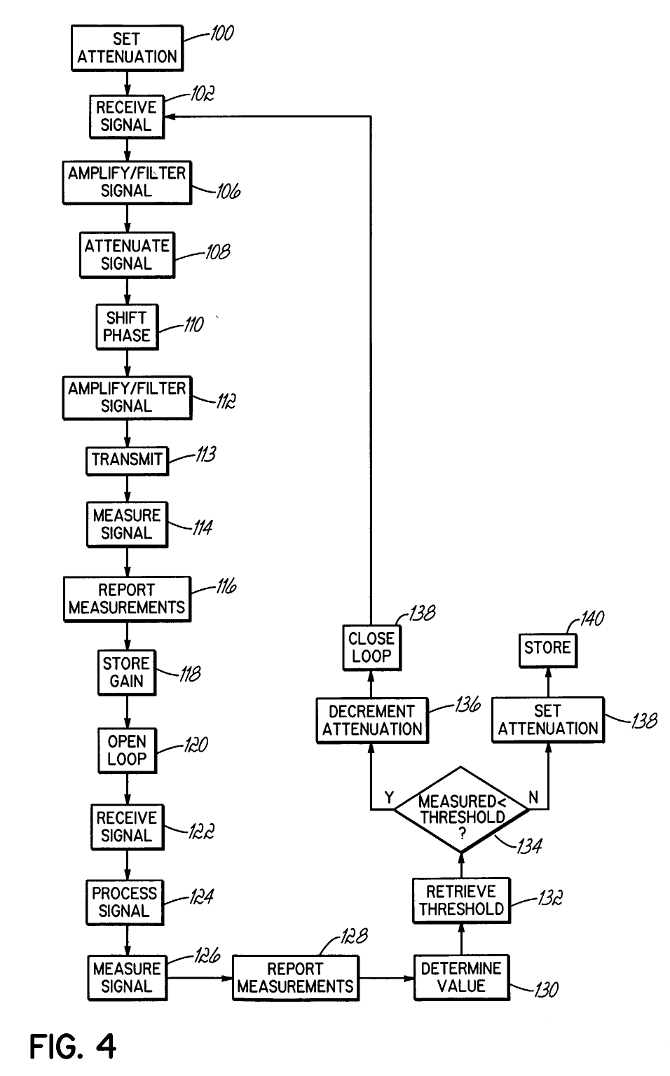

The flowchart of FIG. 4 shows an exemplary methodology suited for execution within the hardware environment of FIG. 2. That is, the steps may have application in dynamically calibrating the gain of a repeater system 20 to avoid incidences of oscillation. Turning more particularly to the flowchart, the attenuator 26 of the repeater 20 may be adjusted to a desired initial setting at block 100. High attenuation lowers the gain within the repeater 20. Thus, an initial high attenuation setting avoids the occurrence of oscillation at the onset of a calibration process, while also conditioning the system 20 for a deliberate and incremental determination of an optimal gain setting.

One of skill in the art will realize that the attenuator setting may be accomplished in a number ways, to include remotely, onsite, and/or according to program protocol automatically executed by the controller 40. Of note, the attenuator 26 may be set to any preset level, and is not necessarily limited to the highest setting at block 100. Other settings may be arrived at over time and through experimentation for efficiency and other processing considerations in accordance with the invention.

Continuing with the flowchart, the receiving antenna registers an incoming signal at block 102. The receiving antenna continuously processes incoming signals from the base station. A signal for purposes of this specification may include multiple signals having on or more different frequencies, each signal may further have multiple channels. The signals may be encoded or otherwise modulated for transmission and other purposes. As the repeater 20 is transmitting, the incoming signal received by the antenna may include feedback from the repeater transmission. Thus, the incoming signal may represent a combination of the base signal, feedback and possibly other signals. Problematically, the relative proportion of the feedback in relation to the base station signal is not precisely known.

The received signal is initially processed by repeater hardware at blocks 106 through 113. For instance, the signals are bolstered and/or filtered at a first amplifier 24 or stages of amplifiers. Other processes undergone by the signal include attenuation at block 108. As discussed in the text describing block 100, the attenuator 26 may be initially set to a relatively high level to avoid oscillation concerns at the onset of a calibration process.

A variable voltage phase shifter 28 sweeps the signal through its entire 360 degree sinusoidal cycle at block 110. The phase shifter 28 may have application in determining the highest possible detected or measured level for the signal, indicating that the distortion ripple's peak is aligned with the maximum signal level. For purposes of the specification, a phase shifter 28 may comprise any suitable device having application in cyclically varying the signal phase. To accomplish this, one skilled in the art should appreciate that multiple phase shifters may be employed as required.

At block 112, the attenuated signal is amplified. One of skill in the art should appreciate that multiple amplifiers could be used in stages to accomplish the amplification at block 112. The amplification may serve to bolster the signal to an acceptable level as required for transmission at block 113. Thus, the signal may be transmitted to a subscriber unit at block 113. As discussed herein, a portion of the transmitted signal is recognized as feedback at the receive antenna at block 102 while the repeater 20 is transmitting at block 113.

The controller 40 initiates measurement of the amplitude at block 114. More specifically, a power detector 38 periodically or continuously samples the signal along its 360 degree sinusoidal path. Of note, the signal used to determine the amplitude measurement at block 114 includes the feedback attributable to the transmitting status of the repeater 20. The power detector 38 is synchronized with operation of the phase shifter 28 to measure the signal at multiple points along the cycle so the peak of the signal is detected. While the measurements typically take place after the signal has been amplified at block 112, they may alternatively or additionally occur at any step of the flowchart. Thus, one of skill in the art should recognize that several such detectors could be employed at different points along the repeater circuit. As such, the power detector 38 of one embodiment may be coupled with the output of second amplifier(s) 30.

The detector 38 communicates the measured amplitude sample(s) to the controller 40 at block 116. The transmission to the controller 40 may be hardwired or wireless. A suitable controller 40 may comprise a microprocessor and/or any device configured to receive and process signals. As such, another suitable controller 40 may comprise a computer or combination of different controllers in accordance with the principles of the present invention.

In one embodiment, the controller 40 may further process the measured amplitude value(s). For instance, the controller 40 may average the samples so as to be in a format that is more compatible with subsequent processing. Thus, the samples detected by the power detector 38 may be processed by the controller 40 to arrive at a peak average.

The controller 40 may also have access to memory 42. Such memory 42 may be integral with the controller 40, such as RAM in the microprocessor. Another memory 42 may comprise a computer database accessible to the controller 40. In any case, the controller 40 may store at block 118 the signal measurements (or averages) detected at block 116. Thus, the average values may be cached for subsequent use in algorithms used to determine an optimal attenuator setting. The current amplitude value may also be stored at block 118. Other system parameters, such as current power levels as well as the attenuation settings may be stored.

The controller 40 initiates activation of a switch 32 at block 120. A suitable switch 32 may comprise a radio frequency switch, or any combination of devices configured to redirect power away from the transmitting antenna. It will be appreciated that the switching status of the switch 32 may be reversible by the controller 40. That is, the controller 40 may deactivate the switch 32, thus reconnecting the transmission antenna to the amplified signal and power when desired. The switch 32, which typically has high isolation characteristics, is positioned in the repeater circuit in accordance with the principles of the present invention.

When so instructed by the controller 40, the feedback loop may be opened via the switch 32, interrupting transmission at block 120. The signal is then shunted to a load 36 rather than being transmitted. At block 122, the receive antenna may receive the incoming signal as before. However, now the incoming signal does not include feedback that was previously attributable to the concurrent transmission by the repeater 20. Thus, the detected signal may consist of the signal from the base station, as well as any incidental noise or other signals stemming from hardware and environmental factors.

The incoming signal is processed at block 124. Those processes may include filtration, amplification and attenuation as substantially accomplished at blocks 106 and 108. The incoming open loop signal is also phase shifted at block 124 to determine the peak amplitude for its sinusoidal cycle. That is, the entire cycle is swept to determine the amplitude of the power signal at a single point or several points along the cycle where, for instance, the base station signal is at its highest. The signal is typically measured at block 126 by the same power detector 38 as was used to measure the incoming signal back at block 114.

The second sequence of measurements is reported to the controller 40 at block 128. Where more than one peak is detected, the controller 40 may average the measured peaks to arrive at a single measurement for processing or other considerations. Per system specifications, the controller 40 may additionally store the second open loop signal(s) detected at block 126 within memory 42 at block 128.

Upon receipt of this second measurement, the controller 40 now has data for both the closed loop and open loop measurements. That is, the controller 40 may recall both the closed loop and open loop measurements detected by the power detector 38. As the signal from the base station is known, and may in fact, remain relatively constant, the difference between the detected closed loop and open loop signals may be attributable significantly to feedback. The noise floor may remain substantially constant between the two measurements, and at least of proportionately less magnitude.

The controller 40 uses the detected closed loop and open loop measurements to arrive at difference value at block 130. For instance, an algorithm executed by the controller 40 at block 130 calculates the difference between the closed and open loop measured values. One skilled in the art should appreciate that any number of other calculations accounting for both the closed loop and open loop measurements may be used to arrive at a suitable value in accordance with the principles of the present invention. Such calculations may be readily accomplished and generally require relatively little processing power and time.

At block 132, the controller 40 accesses threshold value. The threshold value may be recalled from a memory 42, any may include a look-up table. The threshold value may alternatively be programmatically calculated in an algorithm executed by the microcontroller at block 132. In either case, exemplary threshold value is determined or accessed as a function of the evaluation processes of block 132. More specifically, the values may be preset to levels appropriate to avoid oscillation. That is, while the threshold value may tolerate acceptable levels of feedback, it may nonetheless function to avoid those higher levels that risk oscillation or other distortions.

The threshold value in one embodiment is updated easily according to reflect changing operating conditions. The threshold data, itself, may be determined as a product or result of multiple factors, including actual gain in the system, the power level of the incoming signal and the settings of the attenuator 26, which may aid in determining the magnitude of the noise floor.

At block 132, should the measured difference value be determined to be of lesser magnitude than the threshold data, then the attenuator setting may be decremented at block 136 to increase the gain of the repeater system. For instance, the attenuator 26 may be decremented by 1 dB. Other increments may be used in accordance with the principles of the present invention, to include those on a sliding scale. One of skill in the art will appreciate that while the comparison of the value to the threshold data may be binary as shown at block 132, other embodiments may use a more sophisticated evaluation processes in accordance with the principles of the present invention.

The controller 40 may reactivate the switch 32 at block 138 in response to the comparison of block 132, effectively causing the repeater 20 to recommence transmission of the signal in a closed loop scenario. As such, the signal received back at block 102 includes feedback from the transmitted signal. In this manner, another iteration of the calibration cycle may continue at block 102. The signal will again be received and processed at blocks 102 and 106, however, the attenuation at block 108 will be diminished by the preset increment (1 dB). Thus, the decrease of the attenuator 26 at block 136 will increase the gain accordingly by about 1 dB. Similarly, the output of the repeater may be switched to a load and further measurements taken.

Measurements with the increased gain will be reflected at block 114. Moreover, a new measured difference value will be calculated by the controller 40 at block 130 and compared against the threshold value at block 132. The cycle may continue until the threshold value is reached or exceeded at block 134, per system preference and design.

In response to the threshold value eventually being reached or exceeded at block 134 of FIG. 4, the setting of the attenuator 26 will be set so as not to be further decremented. In accordance with another aspect of the invention, the attenuator setting may be further augmented by a safety margin at block 138. That is, the attenuation level may be increased by a certain amount from the attenuator level that achieved the measured signal level reaching/exceeding the magnitude of the threshold value at block 132. For example, the attenuator may be incremented a margin of 5 dB or some other setting to further ensure no oscillation. This feature at block 138 effectively backs off the grain to avoid anomalous RF occurrences that could result in oscillation even within a closely calibrated repeater system 20. This attenuator/gain setting may be recorded at block 140 for future analysis and use. In any case, once the appropriate level of gain is achieved and set, it is used for the operation of the repeater.

One of skill in the art should appreciate that the order of the steps of FIG. 4 could be rearranged, as well as the steps, themselves, omitted, augmented, supplanted or otherwise modified in accordance with the principles of the present invention. For instance, the measurement of the open loop peak values could be accomplished prior to measurement of the peaks in the closed loop, feedback-laden signal.

Moreover, while the present invention has been illustrated by a description of various embodiments, and while these embodiments have been described in considerable detail, it is not the intention of the applicants to restrict or in any way limit the scope of the appended claims to such detail. For instance, one embodiment consistent with the present invention uses a narrow band filter inline with the power detector 38 of FIG. 2 to detect the valley of the feedback-induced sinusoidal signal. That is, rather than just measuring the maximum open or closed loop signals, actual valleys of the signals might be detected. The narrow band filter may facilitate detection of the sinusoidal signal extremes by ensuring that only one signal is evaluated by the power detector 38, thereby avoiding anomalies attributable to other signals. The controller 40 may use a detected valley in conjunction with the peak measurements to determine, for instance, the magnitude of the gain and/or feedback. For example, the peak and valley measurements may be processed as a function of the above discussed equation: A_{(loop amplitude)}=(Aₘₐₓ−Aₘᵢₙ)/(Aₘₐₓ+Aₘᵢₙ), with the measured valley comprising Aₘᵢₙ. Where desired, the measured value is compared to threshold value data to further calibrate the repeater system 20 substantially as described above. This embodiment eliminates the switch 32 and load 36 requirements as only the closed loop measurements are needed. This embodiment further prevents the repeater system 10 from experiencing any transmission interruptions.

The calibration of the repeater of the present invention may be automatic or may require activation, such as by a technician. For example, the repeater may operate to calibrate automatically each day or some other shorter or longer interval. The calibration preferably occurs relatively quickly in order to minimize the interference with its operation. Also, automatic calibration might be set to occur at times which are low traffic periods, such as at night.

Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of applicant's general inventive concept.

What is claimed is:

1. A repeater, comprising:
receiving and transmitting antennas and repeater circuitry configured to receive and transmit a plurality of signals;
a switching circuit configured to switch transmit signals in a first position to the transmitting antenna and in a second position to a load;
a variable attenuator configured to adjust a gain of the repeater circuitry;
a power detector configured to detect signal levels of the transmit signals with the switching circuit alternatively in the first and second position; and
controller circuitry configured to compare a value reflective of the detected first position and second position signal levels against threshold values and to vary a setting of the variable attenuator in response to the comparison.

2. The repeater of claim 1, wherein the power detector determines a peak amplitude of the first position signal level to yield a first position value.

3. The repeater of claim 1, wherein the controller circuitry averages a plurality of peak amplitudes of a plurality of first position signal levels to determine a first position value.

4. The repeater of claim 3, further comprising memory for storing the first position value.

5. The repeater of claim 1, wherein the controller is coupled to the switching circuit and initiates switching the transmit signals alternatively to the transmitting antenna and the load.

6. The repeater of claim 1, wherein the controller is operable to manipulate the first and second position signal levels using at least one function selected from a group consisting of: subtraction, multiplication, a logarithmic function, a trigonometric function, addition and division.

7. The repeater of claim 1, wherein the threshold values are reflective of at least one factor selected from a group consisting of: system gain, system power levels and the attenuation setting of the variable attenuator.

8. The repeater of claim 1, wherein the controller circuitry initiates recalling the threshold values from memory.

9. The repeater of claim 1, wherein the controller circuitry initiates updating the threshold values.

10. The repeater of claim 1, wherein the controller circuitry is further operable to modify the setting of the variable attenuator an additional preset amount in response to the comparison.

11. The repeater of claim 1, further comprising a variable phase shifter, the controller circuitry operable to sweep the variable phase shifter so the detector detects multiple signal levels for the first and second position.

12. The repeater of claim 11, wherein the power detector is operable to detect peak first and second position signals of the phase swept signals.

13. The repeater of claim 1, wherein the controller circuitry is operable to determine a difference between first position signals and second position signals to yield a measured difference value.

14. The repeater of claim 13, wherein the measured difference value is compared to a threshold value.

15. The repeater of claim 1, wherein the threshold values are retrieved from a lookup table.

16. The repeater of claim 1, wherein the threshold values are calculated.

17. The repeater of claim 1, wherein the controller circuitry automatically compares values of detected signals and vary the setting of the variable attenuator.

18. A repeater, comprising:
receiving and transmitting antennas and repeater circuitry configured to receive and transmit a plurality of signals;
a switching circuit configured to switch transmit signals in a first position to the transmitting antenna and in a second position to a load;
a variable attenuator configured to adjust a gain of the repeater circuitry;
a power detector configured to detect signal levels of the transmit signals with the switching circuit alternatively in the first and second position; and
controller circuitry configured to automatically vary a setting of the variable attenuator in response to the detected signal levels.

19. A repeater, comprising:
receiving and transmitting antennas and repeater circuitry configured to receive and transmit a plurality of signals;
a switching circuit configured to switch transmit signals in a first position to the transmitting antenna and in a second position to a load;
a variable gain adjusting circuit configured to adjust a gain of the repeater circuitry;
a power detector configured to detect signal levels of the transmit signals with the switching circuit alternatively in the first and second position; and
controller circuitry configured to compare a value reflective of the detected first position and second position signal levels against threshold values and to vary the gain of the repeater circuitry via the variable gain adjusting circuit in response to the comparison.

20. A method of calibrating gain in a repeater, comprising:
detecting a first amplitude measurement of a first incoming signal received by a repeater while the repeater is transmitting;
detecting a second amplitude measurement of a second incoming signal received by the repeater while the repeater is not transmitting;
determining a value using both the first and second amplitude measurements;
comparing the value to a threshold value; and
adjusting an attenuation level in response to the comparison.

21. The method of claim 20, wherein detecting the first amplitude measurement further includes shifting a phase of the first incoming signal.

22. The method of claim 20, wherein detecting the first amplitude measurement further includes determining a peak amplitude of the first incoming signal.

23. The method of claim 20, wherein detecting the first amplitude measurement further includes averaging a plurality of peak amplitudes of the first incoming signal.

24. The method of claim 20, wherein detecting the first amplitude measurement further includes diverting power to a transmitting antenna.

25. The method of claim 20, further including storing the first amplitude measurement within a memory.

26. The method of claim 20, further including communicating the first amplitude and the second amplitude measurements to a controller.

27. The method of claim 20, wherein detecting the second amplitude measurement further includes storing the second amplitude measurement within the memory.

28. The method of claim 20, wherein detecting the second amplitude measurement further includes shifting a phase of the second signal.

29. The method of claim 20, wherein detecting the second amplitude measurement further includes diverting power away from a transmitting antenna.

30. The method of claim 20, wherein detecting the second amplitude measurement further includes determining a peak amplitude of the second signal.

31. The method of claim 20, wherein determining the value further includes manipulating the first and the second amplitude measurements using at least one function selected from a group consisting of: subtraction, multiplication, a logarithmic function, a trigonometric function, addition and division.

32. The method of claim 20, wherein determining the value further includes using a controller to accomplish the determination.

33. The method of claim 20, wherein comparing the mathematical value to the threshold value further includes determining the threshold value from at least one factor selected from a group consisting of: gain, power and attenuation.

34. The method of claim 20, wherein comparing the value to the threshold value further includes recalling the threshold value from the memory.

35. The method of claim 20, further including updating the threshold value.

36. The method of claim 20, wherein adjusting the attenuation level further includes decrementing the attenuation level in the repeater.

37. The method of claim 20, wherein adjusting the attenuation level further includes incrementing the attenuation level in the repeater.

38. The method of claim 20, wherein adjusting the attenuation level further includes modifying a level of attenuation an additional preset amount in response to the comparison.

39. A method for calibrating gain within a repeater, comprising
detecting a peak measurement of an incoming signal received by a repeater;
detecting a valley measurement of the incoming signal received by the repeater;
determining a mathematical value using both the peak and valley measurements;
correlating the mathematical value to a threshold value associated with an attenuation level; and
adjusting the attenuation level in response to the correlation.

40. The method of claim 39, further comprising filtering the signal with a narrow band filter.
